(19) United States
(12) Patent Application Publication
(10) Pub. No.: US 2003/0065855 A1
(43) Pub. Date: Apr. 3, 2003

(54) Imbedded interrupt

(76) Inventor: Steve R. Webster, Raymond, NH (US)

Correspondence Address: Larry I. Golden, Square D Company, 1415 South Roselle Road, Palatine, IL, 60067, US

(21) Appl. No.: 10/217,155

(22) Filed: Aug. 12, 2002

Related U.S. Application Data
(63) Continuation-in-part of application No. 09/903,899, filed on Jul. 12, 2001.
(63) Continuation-in-part of application No. 10/096,354, filed on Mar. 12, 2002.

(51) Int. Cl. G06F 13/24

(52) U.S. Cl. 710/260

(57) ABSTRACT

A system and method for triggering interrupt service routines is disclosed. The system can be implemented in a computer readable medium that includes logic for receiving first and second signals. The first signal triggers a first interrupt that triggers a first interrupt service routine that is designed to process a first task. The second signal trigger is designed to cause the processing of a second task. The medium also includes logic for determining if the second task is a high priority task, and logic for creating a second interrupt if the second task is a high priority task. The medium further includes logic for completing the first interrupt service routine before processing a second interrupt service routine. The second interrupt service routine is triggered by the second interrupt. The second interrupt service routine is designed to complete the high priority task. And, the medium includes logic for returning to a main loop after completing the second interrupt service routine.

### CROSS-REFERENCE TO RELATED APPLICATIONS

This application is a continuation-in-part of copending U.S. utility application entitled, “Module Control System,” having Ser. No. 09/903,899, filed Jul. 12, 2001. This application is also a continuation-in-part of copending U.S. utility application entitled, “Imbedded Interrupt Handler,” having Ser. No. 10/096,354, filed Mar. 12, 2002.

### TECHNICAL FIELD

The present invention is generally related to a system and method for processing interrupts and associated interrupt service routines and, more particularly, is related to a system and method for imbedding a second interrupt for high priority tasks in an interrupt service routine triggered by a first interrupt.

### BACKGROUND

Control systems may include a controller. A controller is any device that receives inputs, acts on the inputs, and generates outputs in response to the inputs. Controllers include devices such as, but not limited to, Programmable Logic Controllers (PLC) and field bus couplers. PLCs and field bus couplers coordinate interaction among connected input and output modules on a communication bus. Typically, the controller monitors the modules and facilitates actions within the control system. PLCs provide a replacement for hard-wired relay and timer logic circuits found in traditional control panels. PLCs offer flexibility in process control since their behavior is based on executing simple programmed logical instructions. PLC installation is generally easier than relay and logic circuits, and amendments are easier to implement. Most modern PLCs offer internal functions such as timers, counters, shift registers, and special functions making sophisticated control possible using even the most modest PLC.

PLCs offer standard input and output interfaces that suit most process plant equipment and machinery. Standard input interfaces are available that permit direct connection to process transducers. Standard output interface circuitry will usually permit direct connection to contactors that energize process actuators such as motors, pumps and valves. Modern PLCs also have the ability to communicate with networks. A user may now monitor and control PLCs from a remote location.

Input and output modules include sensors, relays, gauges, valves, message displays, switches, limit switches, proximity switches, motor starters, motor controllers, and other like devices as well as traditional Input/Output (I/O) modules for control systems. The input module monitors, or senses, a condition. A signal representing the condition is received by the input module and transmitted to the PLC for processing. The PLC utilizes the representative signal according to a specific function. Generally, the function requires the PLC to perform an operation related to the signal and transmit the result of the operation to the appropriate output module. In this way, the PLC may monitor inputs of a process under control and possibly from the network. Based on the program being executed in memory, the PLC may energize appropriate outputs. The control operating system, which controls the behavior of the PLC, can be modified permitting the entire operation of the external hardware to be altered without the need to disconnect or reroute wiring.

Such a control process may include a production assembly line, such as a bottling process, wherein an input module senses the presence of a liquid within a passing bottle. If the input module senses that a passing bottle does not contain a liquid, the input module transmits a signal alerting the PLC to this irregularity. The PLC receives the signal from the input module and utilizes it to determine if further action is needed. If so, the PLC will transmit a control-type signal to the selected output module for a responsive action, such as removing the empty bottle from the production line or halting the conveyor belt transporting the bottle.

It is apparent that monitoring the liquid-filled bottles requires communication between the modules and the controller. Communication between the input and output modules requires participation of the controller. In developing a control system, the process designer must be cognitive of the timing parameters and limitations associated with controller communication. For the above bottling process, the production assembly rate should not operate at a speed greater than the sum total of the inherent delays in the control system; otherwise, the control system cannot react to the irregularities, such as an empty or uncapped bottle that could evade removal or identification even though the system has detected an imperfection. The industry is in need of systems and methods that allow the production assembly rates to increase by reducing delays in the control system.

Operating systems, such as those of the PLC and the I/O modules, may run in a main loop where the program executes from a first task to a last task and back to the first task. The loop may be interrupted to perform an auxiliary task that is outside of the main loop. The operating system may also run multiple parallel processes (threads) that may not all share equal processor (CPU) time.

PLCs may have hardware interrupt inputs for fast response to external events. The interrupt sets a flag that is tested by the control operating system. The flag may call for an auxiliary task to be performed. The control operating system determines whether the flag applies to the PLC and determines the priority of the flag if the flag applies to the PLC. However, the auxiliary task is generally performed after the control operating system reaches the end of its predetermined cycle. The interrupt is generally unavailable to the PLC between the time it is triggered and the time the background task is initiated. Thus, undesirable delay is introduced into the system.

### SUMMARY

The present invention provides a system and method for triggering interrupt service routines from a main loop. In general terms, the system can be implemented in a computer readable medium where the computer readable medium includes the following logic: (1) Logic for receiving a first interrupt signal and a second interrupt signal, the first interrupt signal triggering a first interrupt, the first interrupt signal being in a protocol format, the first interrupt triggering a first interrupt service routine, the first interrupt service routine designed to process a first task; (2) Logic for receiving a second interrupt signal, the second interrupt signal designed to cause the processing of a second task; (3) Logic for determining if the second task is a high priority task; (4) Logic for creating a second interrupt if the second task is a high priority task; (5) Logic for completing the first interrupt service routine before processing a second interrupt service routine, the second interrupt service routine being triggered by the second interrupt, the second interrupt service routine being designed to complete the high priority task; and, (6) Logic for returning to a main loop after completing the second interrupt service routine.

The present invention can also be viewed as providing a method for processing interrupts, the method comprising the steps of: receiving a first interrupt signal, the first interrupt signal triggering a first interrupt, the first interrupt signal being in a protocol format, the first interrupt triggering a first interrupt service routine, the first interrupt service routine designed to process a first task; receiving a second interrupt signal, the second interrupt signal designed to cause the processing of a second task; determining if the second task is a high priority task; creating a second interrupt if the second task is a high priority task; completing the first interrupt service routine before processing a second interrupt service routine, the second interrupt service routine being triggered by the second interrupt, the second interrupt service routine being designed to complete the high priority task; and returning to a main loop after completing the second interrupt service routine.

Other systems, methods, features, and advantages of the present invention will be apparent, or will become apparent, to one having ordinary skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of a first control system, the first control system includes modules, the modules have object dictionaries;

FIG. 2 is a block diagram of a second control system;

FIG. 3 is a block diagram of a reflex function in a module object dictionary of FIGS. 1 and/or 2;

FIG. 4 is a block diagram of another reflex function in a module object dictionary of FIGS. 1 and/or 2;

FIG. 5 is a block diagram of a system for configuring the reflex function of FIGS. 3 and/or 4;

FIG. 6 is a graphical depiction of an integer comparison, the integer comparison is a first example of a reflex function;

FIG. 7 is a block diagram of a counter, the counter is a second example of a reflex function;

FIG. 8 is a graphical depiction of a timer, the timer is a third example of a reflex function;

FIG. 9 is a comparison timing diagram depicting the reaction time of a control system that includes a reflex function and a control system that does not include a reflex function;

FIG. 10 is a block diagram of a production assembly control system that includes a reflex function;

FIG. 11 is a block diagram of a third control system, the third control system includes a programmable logic controller;

FIG. 12 is a block diagram representative of the programmable logic controller of FIG. 11, and/or the modules of FIGS. 1 and 2, the block diagram includes a control operating system, the control operating system includes an imbedded interrupt system;

FIG. 13 is a flowchart of the imbedded interrupt system of FIG. 12.

### DETAILED DESCRIPTION

The present invention is generally related to a system and method for processing interrupts and associated interrupt service routines and, more particularly, is related to a system and method for imbedding a second interrupt for high priority tasks in an interrupt service routine triggered by a first interrupt. The imbedded interrupt reduces the delay between an interrupt for a high priority task and the processing of the interrupt service routine associated with the high priority interrupt. Among other applications, the invention may be implemented in a controller such as, but not limited to, a Programmable Logic Controller (PLC), an input module, and an output module. Among other applications, the invention may be implemented in control systems that include PLCs, and control systems that bypass PLCs through the use of the invention.

A control operating system of a controller and/or a module may run in a main loop in which a series of main tasks are performed in a sequential order. An interrupt is commonly used to provide a flag indicating that a task outside of the main loop must be performed. The flag may be included in a flags register. An interrupt service routine completes the task outside of the main loop. In prior art, interrupt service routines are often processed after the last main task in the main loop. If the interrupt occurs in the early portions of the main loop, detrimental delay is introduced before the background task is processed. The detrimental delay, also referred to as “jitter,” may be between one hundred and several thousand microseconds. In the current invention, the interrupt may occur at any time during the main loop.

Interrupts may be processor-generated, external hardware interrupts, and software interrupts. Common interrupts for control systems include a discrete input module filter routine and an output module controller area network (CAN) interrupt. A signal triggering the first interrupt may be received by any means. One means for receiving the signal is the port B pin 4 bit position 0x10 hex of an STMicroelectronics microcontroller, such as Model No. ST72F521. The interrupt may be triggered by a high or low voltage signal at the input device. An interrupt vector table may be used to match interrupts with corresponding interrupt service routines.

Input and output modules may be connected to a communication bus or a network. The input module has an input or a number of inputs that are responsive to one or more connected devices, each device having one or more conditions being represented by a respective signal. In response to the representative signal received by the input module, the input module will transmit the signal onto the communication bus. A single input module can accept multiple signals and place them all onto the communication bus for transmission to the controller. In some cases, the representative signals are transmitted onto the communication bus in response to changes in the representative signals themselves. An output module receives one or all of the representative signals. The output module performs an operation on the signal and outputs the result, a state signal, onto the communication bus wherein subsequent actions are administered throughout the control system. The resulting state signal can cause one or more things to occur such as, but not limited to, bus communication can be updated, hardwired outputs can be updated, and the state signal can be stored in the controller, field bus controller or module, for later operations. The control system may be associated, and/or include, a network. The control system may employ a communication protocol such as, but not limited to, Controller Area Network (CAN), Profibus, Interbus, Devicenet, and Ethernet.

In some control systems, the input and output modules can communicate directly and there is no need for a controller in the system. In control systems that include a PLC, the ability for the modules to communicate without interaction of the PLC allows the PLC to be utilized in a more effective manner.

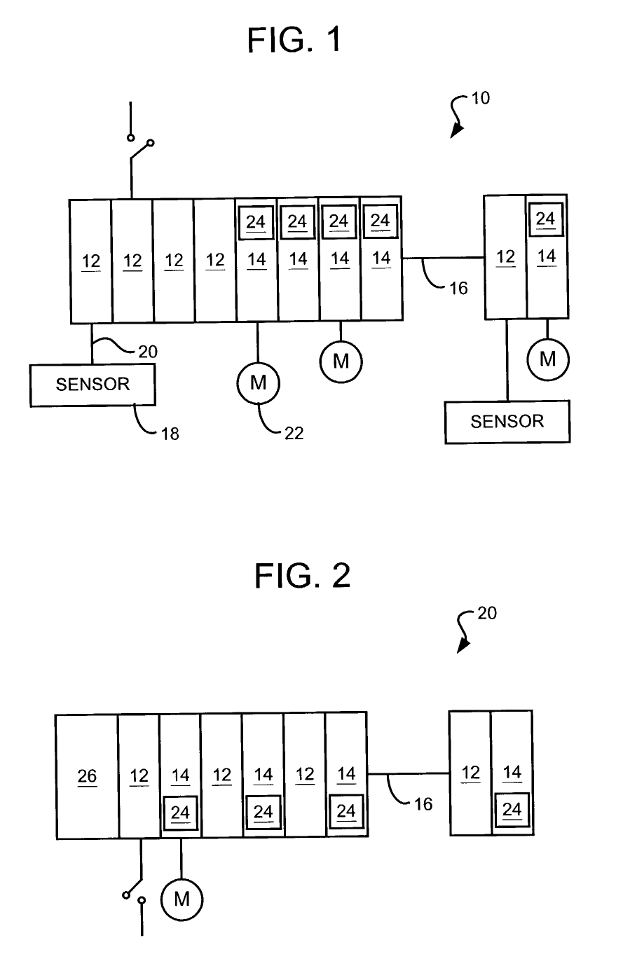

FIG. 1 is a block diagram of a first control system 10. First control system 10 includes input modules 12 and output modules 14. Modules 12 and 14 are connected to a communication connection 16. Communication connection 16 may be any of a variety of connections such as, but not limited to, a network and a communication bus. Modules 12 and 14 may be connected to a device such as sensor 18, each device having one or more conditions. A condition is used as a factor for controlling the condition itself or a related operation. Control system 10 may use protocols such as, but not limited to, Controller Area Network (CAN), Profibus, Interbus, Devicenet, and Ethernet.

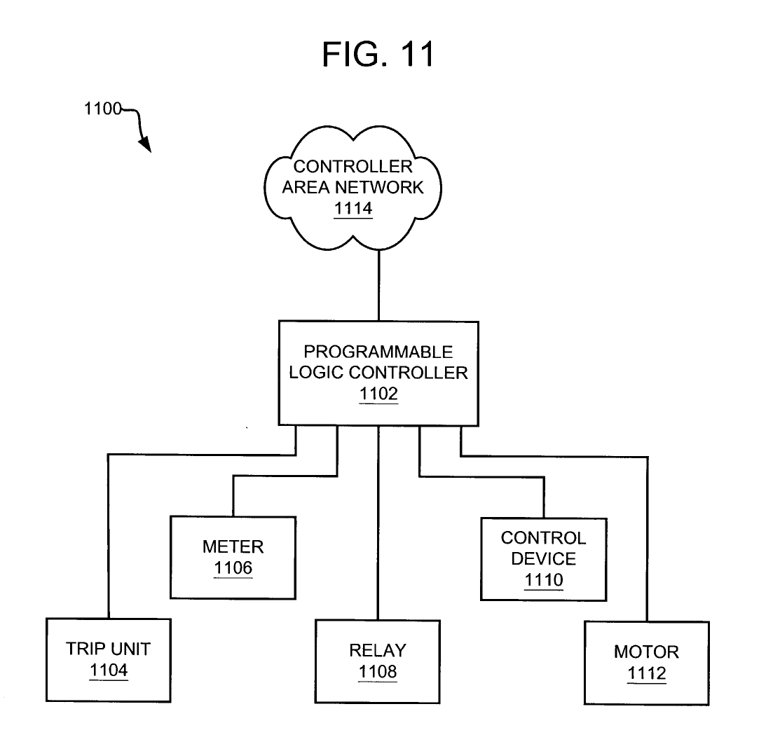

The input modules 12 and output modules 14 include, but are not limited to, sensors, relays, gauges, valves, message displays, switches, limit switches, proximity switches, motor starters, motor controllers and any other like device as well as traditional Input/Output (I/O) modules for control systems. The I/O modules communicate directly with each other in first control system 10, without utilizing a controller. As opposed to system 20 (FIG. 2) and 1100 (FIG. 11) where the I/O modules may communicate through controller 26, and PLC 1102. The present invention allows direct communication between the I/O modules regardless of whether a controller is included in the system.

Input module 12 monitors a device condition to be controlled by control system 10. The condition is represented by a signal. Input module 12a is responsive to the condition via interconnection 20 with the representative signal. Input module 12a will transmit the representative signal to an output module 14a and/or the communication connection 16. Preferably, the input module 12a will not transmit the representative signal until a change in the signal occurs. The output module 14b includes the imbedded interrupt system. The output module 14a is responsive to the representative signal wherein the imbedded interrupt system utilizes the signal for operation within the control system 10. Preferably, the output module 14a converts the representative signal into a state signal. The output module 14a can transmit the state signal onto the communication connection 16, to an input module 12, to an output module 14, to another device, such as motor 22, or to a combination thereof.

Output module 14a includes a control loop comprising the monitoring and controlling of the device condition, including: the input module's receipt of the representative signal from the device, the transmission of the representative signal to the imbedded interrupt system 18 of the output module 14 and the subsequent output of the output module. Preferably, the output of the output module 14a is utilized to ultimately control the device condition or some other similar condition monitored by the control system 10. Similarly, the input module 12a can include a reflex function 24 for converting the representative signal to a state signal.

The simple function 18 of the output module 14 utilizes the representative signal transmitted by the input module 12 to reflexively respond to the distinct representative signal received from the input module 12. This reflex function 24 is capable of converting the representative signal into a state signal wherein the output of the reflex function 24 can be transmitted onto the communication connection 16, transmitted to another module, directed to an output on the output module 14a or stored in the control system 10 for later use.

The state signal may be stored in linked or cascaded modules and reflex functions. Cascading allows a reflex output or resultant state signal to be used as an input to other reflex functions 24. In addition, if controller 26 (FIG. 2) is a non-interrupt based controller, a virtual input/output location can be used as a memory scratch pad to hold reflex function outputs for later use. The scratch pad stores intermediate state signals. Furthermore, the output of the output module 14 can also be stored on the output module itself. Alternatively, the input module 12 or a field bus coupler can store the state signals. An Input/Output (I/O) table in the non-interrupt based controller can be used to exchange the process diagnostics information or reflex function conditions. The output of the output module 14 can also be stored within the non-interrupt or the field bus coupler.

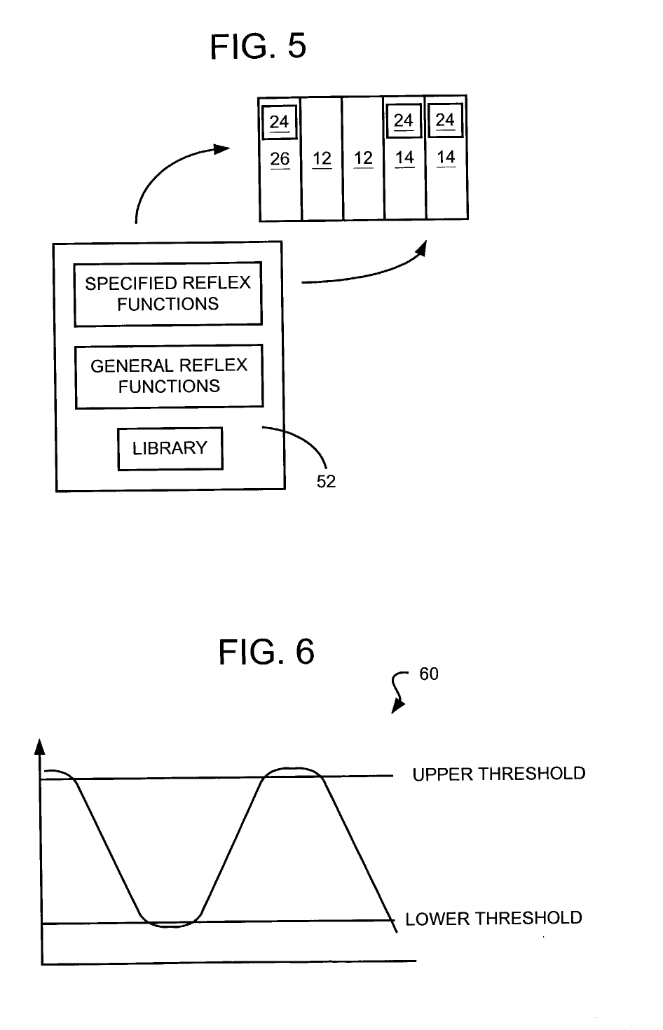

The reflex function 24 is a routine that performs a specific, unsophisticated action on an input signal within the control system 10. Preferably, a PC-based configuration tool 52 (FIG. 5) is utilized to configure the reflex function 24 on the output module 14, input module 12, controller 26 or fieldbus coupler. However, any means for configuring the reflex function 24 to the output module 14, input module 12, or fieldbus coupler may be utilized, including, but not limited to: a programmable logic controller 1102 (FIG. 11), a modular design circuit, an EPROM, an EEPROM, a programmable magnetic card, an exchangeable integrated circuit, HMI, etc.

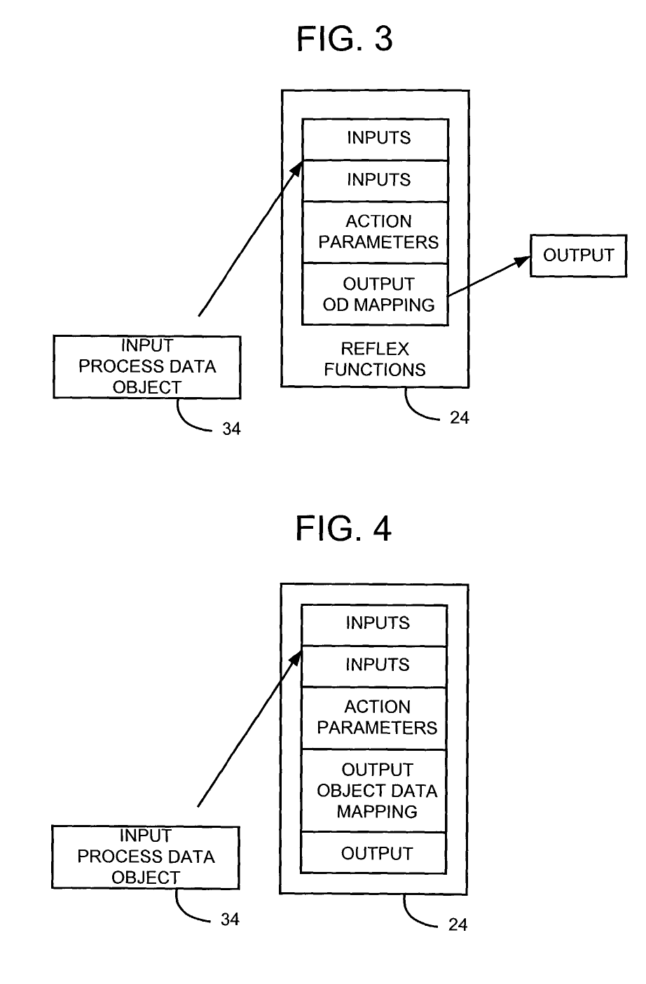

The reflex function 24 may be implemented statically in the firmware of the modules 12 and 14, controller 1102 (FIG. 11), or fieldbus coupler. Alternatively, the reflex function 18 can be hardwired logic within these devices. The scope of the reflex function 24 configuration involves determining which input and output modules 12 and 14 to utilize and the interaction between the modules on the control system. Many modules will not have non-volatile memory, so the reflex function 24 is specified using entries in the manufacturer specific CANopen object dictionary 34 (FIGS. 3 and 4). The object dictionary 34 is loaded into the input and output modules 12 and 14 during bootup. The object dictionary 34 is either loaded from a device somewhere on the network, or created within the modules 12 and 14 during bootup. This allows for configuration of the reflex function 24 during bootup or during a hot-swap of a module by a standard CANopen configuration manager.

In one embodiment, the reflex function 24 is configured to execute within the output module 14 that receives the representative signal transmitted by the input module 12. The result of the reflex action performed on the representative signal is a state signal. The state signal is transmitted by the output module 14 to the communication connection 16. In this way, the control system 10 operates without a controller. The control system 10 decreases communication time over the communication connection 16, thus increasing the efficient use of the system's bandwidth by improving the control response time.

In addition, the reflex function 24 of several output modules 14 can be cascaded together. Cascading allows a reflex output or resultant state signal to be used as an input to other reflex functions 24. The resultant state signal can update a hardwired input, thereby terminating the cascading. In another embodiment, the resultant signal can be placed onto the communication connection 16 as an input to another reflex function 24. In a further embodiment, the resultant signal can be stored for later use, temporarily terminating the cascading. In a still further embodiment, cascading can be accomplished with fieldbus couplers and input modules 12.

FIG. 2 is a block diagram of a second control system 28. Control system 28 includes controller 26. Controller 26 may be any controller, such as, but not limited to, a non-interrupt based controller, and a PLC. The state signal output of the output module 14 can be transmitted to the controller 26 that is monitoring the control system 28. The controller 26 reads the state signal output into its buffer and stores it for later use by using a temporary memory in the controller 26. The temporary memory provides a storage location for an intermediate value, thus reducing the workload of the controller 26. The controller includes an I/O table that can be utilized to exchange process diagnostics or reflex logic conditions. A fieldbus coupler (not shown) may also perform these functions. A fieldbus coupler includes a memory and a processor for storing and retrieving state signals. A fieldbus coupler acts as a gateway between the local communication connection and a remote communication connection.

The types of actions performed by the reflex function 24 include, but are not limited to: Boolean logic, comparisons, counters, timers and edge detection. The reflex functions 24 can be defined between system inputs and outputs and can also cross modules 12 and 14. Reflex functions 24 may be reflex functions as described in IEC 1131. Those having ordinary skill in the art are familiar with IEC 1131. IEC 1131 is entirely incorporated by reference.

Reflex function 24 is capable of executing Boolean logic on the representative signal received by the output module 14. Such Boolean logic operations include, but are not limited to: AND, OR, XOR, NAND, and XNOR. Reflex function 24 is also capable of comparing an integer value against a threshold level, for example, <, >, and =. FIG. 6 is a graphical depiction 60 of an integer comparison.

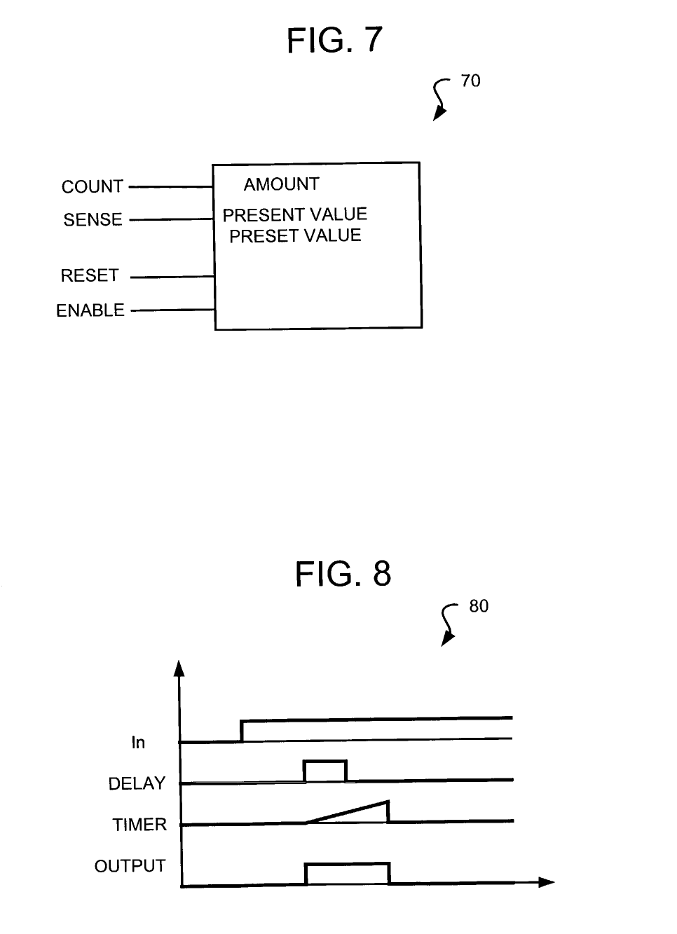

FIG. 7 is a block diagram of a counter 70. Counter 70 is a second example of a reflex function. Counter operations such as, but not limited to, “up”, “down”, “up/down”, “flip-flop”, SR, RS (with “hold last value” and defined initial value), can also be performed by a reflex function 24. Reflex function 24 may count the pulses associated with an input module 12. The count total can be transmitted throughout the control system or stored in the output module 14.

FIG. 8 is a graphical depiction of a timer 80. Timer 80 is a third example of a reflex function. Some timers that can be configured within the output module 14 include, but are not limited to: on, off, delay to start, delay to stop, calibrated pulse on input rising edge, and calibrated pulse on input falling edge. The reflex function 24 can also be configured to detect edge transitions of a signal. The edge detection can be performed on the rising or falling edge of the signal. Some other control functions performed by the reflex function 24 include two-position hysteresis and action/reaction diagnostics.

Reflex function 24 is well suited for applications constrained by critical timing concerns. Reflex function 24 facilitates a high-speed reaction to changes in critical conditions requiring a fast, localized response. Reflex function 24 provides a simple, reflexive output similar to an “intelligent relay,” without requiring training for sophisticated IEC compatible logic.

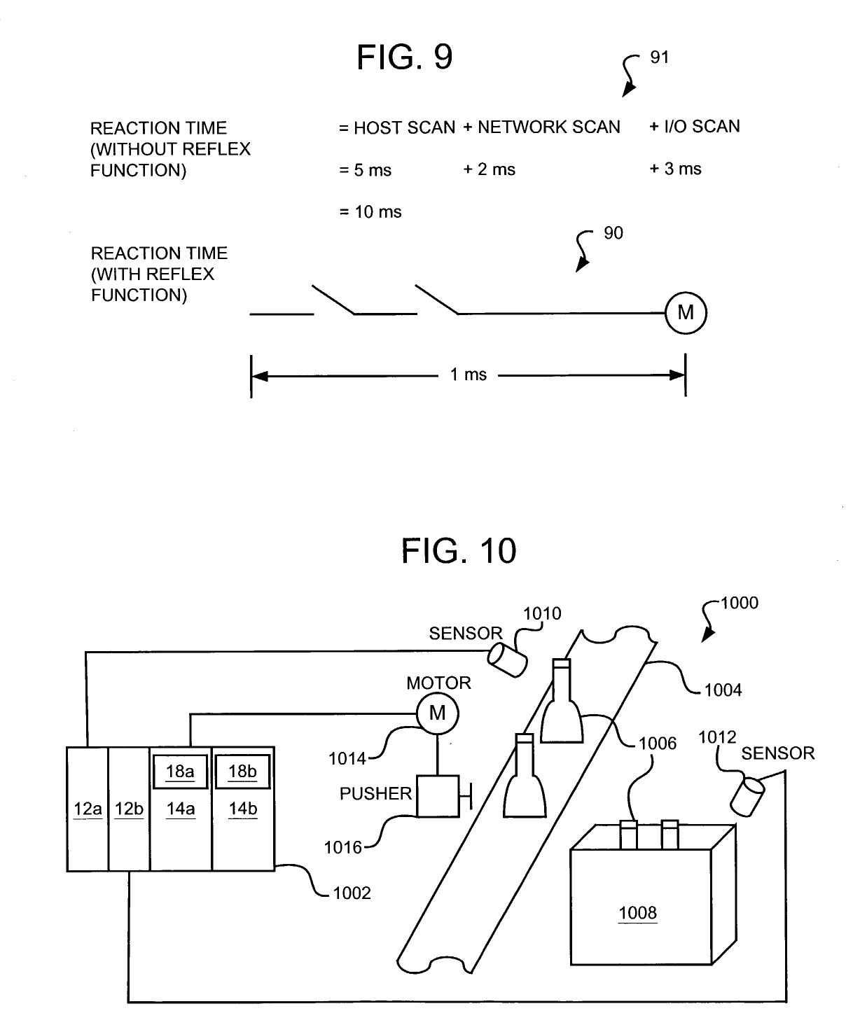

FIG. 9 is a comparison timing diagram 90 and associated equation 91 depicting the reaction time of a control system that includes a reflex function 24 and a control system that does not include a reflex function 24. A fieldbus network and a controller 26 are slower than the near immediate, “responsive,” actions capable of an output module 14 having reflex function 24. The combination of a controller's processing time in addition to the network time as well as the bus time, will generally be greater than 10 ms as shown in equation 91. Controller-less control systems incorporating output modules 14 comprising reflex functions 24 are capable of providing similar control functionality to a control system utilizing a controller 26, but with a significant reduction in time.

The integration of one or more reflex functions 18 can greatly benefit a control system having critical timing situations involving input and output modules 12 and 14. Such situations can be managed with minimal logic combinations between input modules 12 and output modules 14. Utilizing a non-interrupt based controller for such a situation adversely affects the time limitation. The non-interrupt based controller scan requires at least three operations. The non-interrupt based controller must first read the input/output scan into a memory location, then solve the logic, and then write the result to an output module 14. The accumulation of the controller's processing time, network time and bus time will be significantly greater than a control system where the reflex function 24 is utilized. Utilizing a controller-less control system incorporates input and output modules 12 and 14 and fieldbus couplers comprising reflex functions 24 that provide satisfactory control functionality, with a significant reduction in system response time. Depending upon the controller processor and bus time, the reflex function 24 can cause a hardwire output to change state as fast as 100-200 microseconds.

FIG. 10 is a block diagram of a production assembly system 1000 having a control system 1002 that includes reflex function 24. FIG. 10 shows a time critical operation involving a bottling assembly process. In the assembly process, clean empty bottles 1004 are transported via conveyor belt 1006. Bottles 1004 are filled with a liquid, sealed with a bottle cap, and placed in a box 1008 for shipping. A bottle cap check ensures the sealing of the bottle and requires immediate actions within 1-2 ms. A controller read, logic solve, and write would extend the system 1002 response time by approximately 10 ms. Instead, a cap sensor 1010 is located near the conveyor belt 1006 and is associated with an input module 12a. Control system 1002 includes other input modules 12, such as input module 12b are associated with box full sensor 1012 and a bottle fill sensor (not shown). Kicker motor 1014 is associated with output module 14a. As capped bottles 1004 move on conveyor belt 1006, cap sensor 1010 senses the presence of the bottle cap and transmits a representative signal of such condition to output module 14a. In the production assembly system 1000, cap sensor 1010 is set to transmit its representative signal to the kicker motor 1014. Upon receiving the representative signal from the cap sensor 1010, the reflex function 24a associated with kicker motor 1014 utilizes the cap sensor signal and reflexively outputs a state signal to the kicker motor 1014 to activate the cylinder 1016 to remove the bottle from the conveyor belt 1006. Alternatively, if the cap sensor 1010 does not sense a bottle cap on the bottle, no cap sensor representative signal will be sent to output module 14a.

Similarly, when the box full sensor 1012 senses that the box 1008 is full, its input module 12b can transmit the representative signal to a predetermined output module 14b to remove the filled box or alert personnel to do the same. The reflex function 24b for the input module 12b of the box full sensor 1012 can be a counter type or some other type. Alternatively, an enable input can be utilized to enable or disable the reflex function 24. A master control relay can also be utilized to enable or disable all functions.

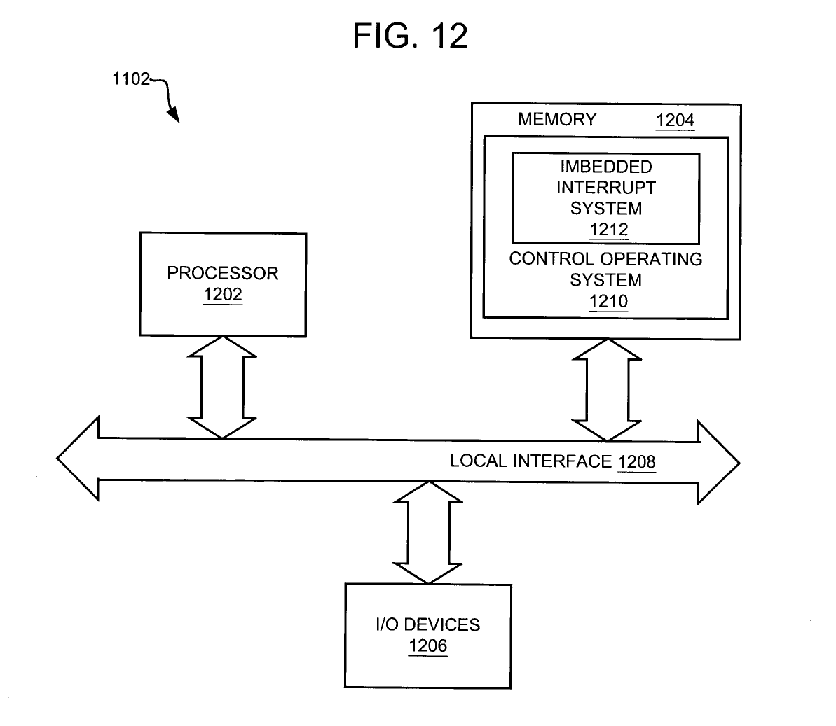

FIG. 11 is a block diagram of a control system 1100 including a programmable logic controller 1102. Programmable logic controller 1102 may communicate with components such as a trip unit 1104, a meter 1106, a relay 1108, a control device 1110, a motor 1112 and a control network. The control network may be a controller area network 1114. The programmable logic controller 1102 includes a control operating system 1210 (FIG. 12). The control operating system 1210 includes an imbedded interrupt system 1212. Imbedded interrupt system 1212 provides an implementation of reflex function 24. Though the imbedded interrupt system 1212 is shown as part of a programmable logic controller in FIGS. 11 and 12, the description provided is also applicable to controller-less systems such as control system 10 (FIG. 1).

The imbedded interrupt system 1212 can be implemented in software (e.g., firmware), hardware, or a combination thereof. In one embodiment, the imbedded interrupt system 1212 is implemented in software, as an executable program, and is executed by a special or general purpose digital computer, such as a programmable logic controller, a personal computer (PC; IBM-compatible, Apple-compatible, or otherwise), workstation, minicomputer, and a mainframe computer. FIG. 12 is a block diagram of programmable logic controller 1102. Programmable logic controller 1102 includes the control operating system 1210. The control operating system 1210 includes imbedded interrupt system 1212. Though FIG. 12 shows imbedded interrupt system 1212 as a portion of the control operating system 1210, the imbedded interrupt system 1212 may also be considered a discrete program that works in conjunction with any operating system such as, but not limited to, those of modules 12 and 14 (FIG. 1).

Generally, in terms of hardware architecture, as shown in FIG. 12, the programmable logic controller 1102 includes a processor 1202, memory 1204, and one or more input and/or output (I/O) devices 1206 (or peripherals) that are communicatively coupled via a local interface 1208. The local interface 1208 can be, for example, one or more buses or other wired or wireless connections, as is known in the art. Local interface 1208 may have additional elements, which are omitted for simplicity, such as controllers, buffers (caches), drivers, repeaters, and receivers, to enable communications. Further, local interface 1208 may include address, control, and/or data connections to enable appropriate communications among the aforementioned components.

Processor 1202 is a hardware device for executing software, particularly software stored in memory 1204. Processor 1202 can be any custom made or commercially available processor, a central processing unit (CPU), an auxiliary processor among several processors associated with the programmable logic controller 1102, a semiconductor-based microprocessor (in the form of a microchip or chip set), a macroprocessor, or generally any device for executing software instructions. Suitable commercially available microprocessors include: STMicroelectronics ST microprocessors, PA-RISC series microprocessors from Hewlett-Packard Company, 80x86 or Pentium series microprocessors from Intel Corporation, PowerPC microprocessor from IBM, Sparc microprocessors from Sun Microsystems, Inc., and 68xxx series microprocessors from Motorola Corporation.

Memory 1204 may include one or more memory elements such as volatile memory elements (e.g., random access memory (RAM, such as DRAM, SRAM, SDRAM, etc.)) and nonvolatile memory elements (e.g., ROM, hard drive, tape, CDROM, etc.). Memory 1204 may also incorporate electronic, magnetic, optical, and/or other types of storage media. Memory 1204 may have a distributed architecture, where various components are situated remote from one another, but can be accessed by the processor 1202.

The software in memory 1204 may include one or more separate programs, each of which comprises an ordered listing of executable instructions for implementing logical functions. In the example of FIG. 12, the software in the memory 1204 includes a control operating system 210. The control operating system 210 includes the imbedded interrupt system 1212. Control operating system 1210 may include portions of commercially available operating systems such as: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal data assistants (PDAs) (e.g., PalmOS available from Palm Computing, Inc., and Windows CE available from Microsoft Corporation). The control operating system 1210 essentially controls the execution of other computer programs and provides scheduling, input-output control, file and data management, memory management, and communication control and related services.

The imbedded interrupt program 1212 is a source program, executable program (object code), script, or any other entity comprising a set of instructions to be performed. When program 1212 is a source program, then program 1212 may be translated via a compiler, assembler, interpreter, or the like. The translator may, or may not, be included within the memory 1204, so as to operate properly with the control operating system 1210. Furthermore, the imbedded interrupt system 1212 can be written as (a) an object-oriented programming language, which has classes of data and methods, or (b) a procedure programming language, which has routines, subroutines, and/or functions, for example C, C++, Pascal, Basic, Fortran, Cobol, Perl, Java, and Ada. In one currently contemplated mode of practicing the invention, the imbedded interrupt system 1212 is written in C.

The I/O devices 1206 may include input devices, for example, digital input modules, contacts, keyboards, a mouse, scanners, microphones, etc. Furthermore, the I/O devices 1206 may also include output devices, for example, digital output modules, a printer, display, etc. Finally, the I/O devices 1206 may further include devices that communicate both inputs and outputs, for instance a modulator/demodulator (modem; for accessing another device, system, or network), a radio frequency (RF) or other transceiver, a telephonic interface, a bridge, a router, and network connections, etc.

The software in the memory 1204 may further include a basic input output system (BIOS) (omitted for simplicity). The BIOS is a set of essential software routines that initialize and test hardware at startup, start the control operating system 1210, and support the transfer of data among the hardware devices. The BIOS is stored in ROM so that the BIOS can be executed when the programmable logic controller 1102 is activated.

When the programmable logic controller 1102 is in operation, the processor 1202 is configured to execute software stored within the memory 1204, to communicate data to and from the memory 1204, and to generally control operations of the programmable logic controller 1102 pursuant to the software. The imbedded interrupt system 1212 and the control operating system 1210, in whole or in part, but typically the latter, are read by the processor 1202, perhaps buffered within the processor 1202, and then executed.

When the imbedded interrupt system 1212 is implemented in software, as is shown in FIG. 12, it should be noted that the imbedded interrupt system 1212 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The imbedded interrupt system 1212 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the imbedded interrupt system 1212 is implemented in hardware, the imbedded interrupt handler system can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The imbedded interrupt handler 1212 addresses the problem of delays in processing from an interrupt to an interrupt service routine. The interrupt may be used to determine if new data is present. If new data is present, the interrupt service routine is called if further work is to be done. The interrupt pin is then free to receive new information. The imbedded interrupt handler sets a secondary interrupt inside the first interrupt. The secondary interrupt will execute the interrupt service routine after the first interrupt is completed.

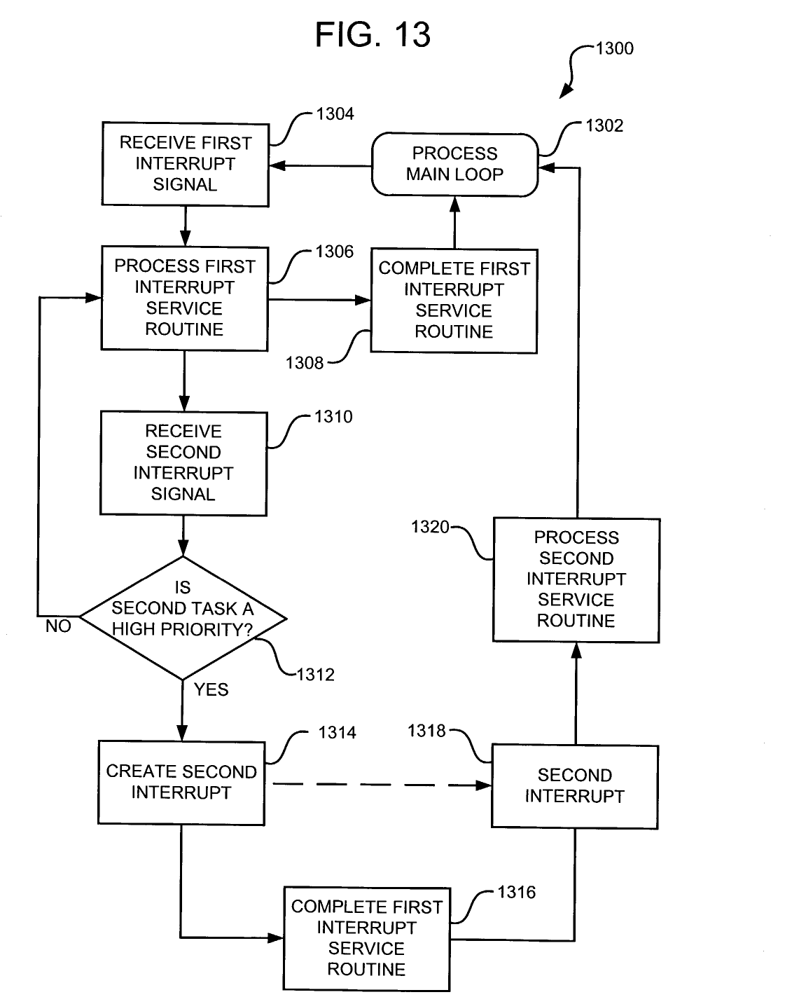

FIG. 13 shows a flowchart 1300 of the imbedded interrupt system 1212 of FIG. 12. The imbedded interrupt system 1212 may be understood as commencing from the main loop. However, there is no required starting point. The imbedded interrupt system may be entered from the processing of an interrupt service routine, processing of the boot program, processing of a configuration program, or any other processing operation known to those having ordinary skill in the art. In block 1302, the processor is processing a portion of the main loop. In block 1304, the imbedded interrupt system 1212 receives a first interrupt signal. The first interrupt signal may be received at an interrupt pin such as port pin 4 having a bit position 0x10 hex of an STMicroelectronics microprocessor. The first interrupt signal may be representative of a first condition at a device, such as sensors 18 (FIG. 1), 1010 and 1012 (FIG. 10).

The first interrupt signal may be in a protocol format such as, but not limited to, controller area network (CAN) message, Profibus, Interbus, Devicenet, and Ethernet. Those having ordinary skill in the art are familiar with the ST microprocessor and CAN messages. The first interrupt signal may be a CANOpen interrupt signal. The CAN message may include a message frame having application data. The message frame may include an identifier and an arbitration field. A node, such as programmable logic controller 1102, input module 12 and output module 14, may use the identifier to determine whether the CAN message applies to the node. If the identifier passes an acceptance filter and/or matches an identifier in an identification table, the CAN message may be received by the node and an interrupt maybe generated for the processor 1202. The identifier may also include an arbitration field. The identifier and its arbitration field may be used to determine the priority of the CAN message.

The receipt of an interrupt signal that applies to the node generally disables the interrupt pin. The request to process a first interrupt service routine may be set up in the manner outlined below:

| //set interrupt for ei3 | |
|---|---|
| ISPR1 &= ˜0x04; | //Set pin 4 for input interrupt |
| //If pin is low set interrupt for low level, if pin is high set interrupt for | |
| high level | |
| if (PBDR & 0x10){ | |
| MISCR2 = 0x40; | //high level interrupt trigger |

}

else {

| | |
|---|---|
| MISCR2 = 0x00; | //low level interrupt trigger |

}

The receipt of a first interrupt signal that applies to the node triggers a first interrupt. The first interrupt triggers a first interrupt service routine. The first interrupt service routine is designed to process a first task. The first task may be a CANOpen message.

In block 1306, the imbedded interrupt system 1212 processes the first interrupt service routine. If the imbedded interrupt system 1212 does not receive a second interrupt signal, the imbedded interrupt system 1212 goes to block 1308. In block 1308, the imbedded interrupt system 1212 completes the first interrupt service routine.

In block 1310, the imbedded interrupt system 1212 receives a second interrupt signal. The second interrupt signal is designed to cause the processing of a second task.

In block 1312, the imbedded interrupt system 1212 determines if the second task is a high priority task. The second task may have a high priority if it is related to a task that should be performed prior to returning to the main loop. The high priority task may be a reflex operation and/or the generation of a state signal. If the second task is not a high priority task, the imbedded interrupt system 1212 returns to block 1306 and continues to process the first interrupt service routine. If the second task is a high priority task, the imbedded interrupt system 1212 goes to block 1314.

In block 1314, the imbedded interrupt system 1212 creates a second interrupt. The second interrupt may be a reflex interrupt. The same port pin that received the first interrupt signal may be enabled to receive the second interrupt signal. An instruction such as “PBOR=0x10; // enable interrupt on port B pin 4,” may be included in the control operating system 1210 in order to enable the second interrupt request. If the same interrupt port is used for several interrupt service routines, a character variable may be used to distinguish between the several interrupt service routines. The bits of the character variable may be used for different interrupt service routines. For example, bit 0=1=first interrupt service routine needs service; and bit 1=1=second interrupt service routine needs service. After block 1314, the imbedded interrupt system 1212 goes to block 1316. In block 1316, the imbedded interrupt system 1212 completes the first interrupt service routine. The imbedded interrupt system 1212 then goes to block 1318.

In block 1318, the imbedded interrupt system 1212 uses the second interrupt created in block 1314 to trigger a second interrupt service routine. The second interrupt service routine is designed to complete the high priority task. The second interrupt routine may be a reflex interrupt service routine. After the second interrupt service routine is completed, the imbedded interrupt system 1212 returns to the main loop.

The description above provides for a second interrupt inside of a first interrupt. The secondary interrupt executes some interrupt service routines as soon as the first interrupt is completed. Excessive asynchronicities between some interrupts and the execution of related interrupt service routines may be eliminated.

Flowchart 1300 of FIG. 13 shows the architecture, functionality, and operation of a possible implementation of the imbedded interrupt system 1210. The blocks represent modules, segments, and/or portions of code. The modules, segments, and/or portions of code include one or more executable instructions for implementing the specified logical function(s). In some implementations, the functions noted in the blocks may occur in a different order than that shown in FIG. 13. For example, two blocks shown in succession in FIG. 13A may be executed concurrently or the blocks may sometimes be executed in another order, depending upon the functionality involved.

It should be emphasized that the above-described embodiments of the present invention, particularly, any “preferred” embodiments, are merely possible examples of implementations, merely setting forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

At least the following is claimed:

1. A computer readable medium for processing interrupts, the medium comprising:
logic for receiving a first interrupt signal, the first interrupt signal triggering a first interrupt, the first interrupt signal being in a protocol format, the first interrupt triggering a first interrupt service routine, the first interrupt service routine designed to process a first task;
logic for receiving a second interrupt signal, the second interrupt signal designed to cause the processing of a second task;
logic for determining if the second task is a high priority task;
logic for creating a second interrupt if the second task is a high priority task;
logic for completing the first interrupt service routine before processing a second interrupt service routine, the second interrupt service routine being triggered by the second interrupt, the second interrupt service routine being designed to complete the high priority task; and
logic for returning to a main loop after completing the second interrupt service routine.

2. The computer readable medium of claim 1, where the protocol of the first interrupt signal is Controller Area Network (CAN) protocol.

3. The computer readable medium of claim 1, where the protocol is one of a group of protocols, where the group consists of Controller Area Network (CAN), Profibus, Interbus, Devicenet and Ethernet.

4. The computer readable medium of claim 1, where the first interrupt signal is a CANOpen interrupt signal.

5. The computer readable medium of claim 1, where the first task is a CANOpen message.

6. The computer readable medium of claim 1, where the high priority task is a reflex operation.

7. The computer readable medium of claim 1, where the second interrupt service routine is a reflex interrupt service routine.

8. The computer readable medium of claim 1, where the second interrupt is a reflex interrupt.

9. The computer readable medium of claim 1, where the second interrupt occurs immediately after the completion of the first interrupt service routine.

10. The computer readable medium of claim 1, where the second interrupt service routine is completed prior to returning to the main loop.

11. The computer readable medium of claim 1, where the first interrupt signal is representative of a first condition of a device, and the second task includes the generation of a first state signal.

12. The computer readable medium of claim 1, where the computer readable medium resides in an input module.

13. The computer readable medium of claim 1, where the computer readable medium resides in an output module.

14. The computer readable medium of claim 1, where the computer readable medium resides in a controller.

15. The computer readable medium of claim 1, where the computer readable medium resides in a control system, and the control system does not include a controller.

16. The computer readable medium of claim 1, where the first interrupt is triggered by receipt of the first interrupt signal at an interrupt pin.

17. The computer readable medium of claim 1, where the first interrupt includes the following instructions:

| //set interrupt for ei3 | |
|---|---|
| ISPR1 &= ˜0x04; | //Set pin 4 for input interrupt |
| //If pin is low set interrupt for low level, if pin is high set interrupt for | |
| high level | |
| if (PBDR & 0x10){ | |
| MISCR2 = 0x40; | //high level interrupt trigger |
| } | |
| else { | |
| MISCR2 = 0x00; | //low level interrupt trigger |
| } | |

18. The computer readable medium of claim 1, where the medium determines whether the second task is a high priority task based on whether the second task should be completed prior to returning to the main loop.

19. The computer readable medium of claim 1, where the first and second interrupt signals are received at the same pin.

20. The computer readable medium of claim 1, where the second request for service is enabled with the instruction,
PBOR=0x10; // enable interrupt on port B pin 4

21. A method for processing interrupts, the method comprising the steps of:
receiving a first interrupt signal, the first interrupt signal triggering a first interrupt, the first interrupt signal being in a protocol format, the first interrupt triggering a first interrupt service routine, the first interrupt service routine designed to process a first task;
receiving a second interrupt signal, the second interrupt signal designed to cause the processing of a second task;
determining if the second task is a high priority task;
creating a second interrupt if the second task is a high priority task;
completing the first interrupt service routine before processing a second interrupt service routine, the second interrupt service routine being triggered by the second interrupt, the second interrupt service routine being designed to complete the high priority task; and
returning to a main loop after completing the second interrupt service routine.

22. The method of claim 1, where the protocol of the first interrupt signal is Controller Area Network (CAN) protocol.

23. The method of claim 1, where the protocol is one of a group of protocols, where the group consists of Controller Area Network (CAN), Profibus, Interbus, Devicenet and Ethernet.

24. The method of claim 1, where the first interrupt signal is a CANOpen interrupt signal.

25. The method of claim 1, where the first task is a CANOpen message.

26. The method of claim 1, where the high priority task is a reflex operation.

27. The method of claim 1, where the second interrupt service routine is a reflex interrupt service routine.

28. The method of claim 1, where the second interrupt is a reflex interrupt.

29. The method of claim 1, where the second interrupt occurs immediately after the completion of the first interrupt service routine.

30. The method of claim 1, where the second interrupt service routine is completed prior to returning to the main loop.

31. The method of claim 1, where the first interrupt signal is representative of a first condition of a device, and the second task includes the generation of a first state signal.

32. The method of claim 1, where the method is practiced using an input module.

33. The method of claim 1, where the method is practiced using an output module.

34. The method of claim 1, where the method is practiced using a controller.

35. The method of claim 1, where the method is practiced in a control system, and the control system does not include a controller.

36. The method of claim 1, where the first interrupt is triggered by receipt of the first interrupt signal at an interrupt pin.

37. The method of claim 1, where the first interrupt includes the following instructions:

| //set interrupt for ei3 | |
|---|---|
| ISPR1 &= ˜0x04; | //Set pin 4 for input interrupt |
| //If pin is low set interrupt for low level, if pin is high set interrupt for | |
| high level | |
| if (PBDR & 0x10){ | |
| MISCR2 = 0x40; | //high level interrupt trigger |
| } | |
| else { | |
| MISCR2 = 0x00; | //low level interrupt trigger |
| } | |

38. The method of claim 1, where the step of determining if the second task is a high priority task is based on whether the second task should be completed prior to returning to the main loop.

39. The method of claim 1, where the first and second interrupt signals are received at the same pin.

40. The method of claim 1, where the second request for service is enabled with the instruction,
PBOR=0x10; // enable interrupt on port B pin 4

41. A system for processing interrupts, the system comprising:
means for receiving a first interrupt signal, the first interrupt signal triggering a first interrupt, the first interrupt signal being in a protocol format, the first interrupt triggering a first interrupt service routine, the first interrupt service routine designed to process a first task;
means for receiving a second interrupt signal, the second interrupt signal designed to cause the processing of a second task;
means for determining if the second task is a high priority task;
means for creating a second interrupt if the second task is a high priority task;
means for completing the first interrupt service routine before processing a second interrupt service routine, the second interrupt service routine being triggered by the second interrupt, the second interrupt service routine being designed to complete the high priority task; and
means for returning to a main loop after completing the second interrupt service routine.

42. The system of claim 1, where the protocol of the first interrupt signal is Controller Area Network (CAN) protocol.

43. The system of claim 1, where the protocol is one of a group of protocols, where the group consists of Controller Area Network (CAN), Profibus, Interbus, Devicenet and Ethernet.

44. The system of claim 1, where the first interrupt signal is a CANOpen interrupt signal.

45. The system of claim 1, where the first task is a CANOpen message.

46. The system of claim 1, where the high priority task is a reflex operation.

47. The system of claim 1, where the second interrupt service routine is a reflex interrupt service routine.

48. The system of claim 1, where the second interrupt is a reflex interrupt.

49. The system of claim 1, where the second interrupt occurs immediately after the completion of the first interrupt service routine.

50. The system of claim 1, where the second interrupt service routine is completed prior to returning to the main loop.

51. The system of claim 1, where the first interrupt signal is representative of a first condition of a device, and the second task includes the generation of a first state signal.

52. The system of claim 1, where the system resides in an input module.

53. The system of claim 1, where the system resides in an output module.

54. The system of claim 1, where the system resides in a controller.

55. The system of claim 1, where the system resides in a control system, and the control system does not include a controller.

56. The system of claim 1, where the first interrupt is triggered by receipt of the first interrupt signal at an interrupt pin.

57. The system of claim 1, where the first interrupt includes the following instructions:

| //set interrupt for ei3 | |
|---|---|
| ISPR1 &= ˜0x04; | //Set pin 4 for input interrupt |
| //If pin is low set interrupt for low level, if pin is high set interrupt for | |
| high level | |
| if (PBDR & 0x10){ | |
| MISCR2 = 0x40; | //high level interrupt trigger |
| } | |
| else { | |
| MISCR2 = 0x00; | //low level interrupt trigger |
| } | |

58. The system of claim 1, where the means for determining if the second task is a high priority task is based on whether the second task should be completed prior to returning to the main loop.

59. The system of claim 1, where the first and second interrupt signals are received at the same pin.

60. The system of claim 1, where the second request for service is enabled with the instruction,
PBOR=0x10; // enable interrupt on port B pin 4
